(19) United States
(12) Patent Application Publication
(10) Pub. No.: US 2024/0418188 A1
(43) Pub. Date: Dec. 19, 2024

(54) Energy Storage System for Overpressure Environments

(71) Applicant: Quidnet Energy Inc., Houston, TX (US)

(72) Inventors: Howard K. Schmidt; Cliff Mauroner, Pittsburgh, PA (US)

(73) Assignee: Quidnet Energy Inc., Houston, TX (US)

(21) Appl. No.: 18/706,320

(22) PCT Filed: Aug. 31, 2023
(86) PCT No.: PCT/US23/31595

§ 371 Date: Apr. 30, 2024

Related U.S. Application Data
(60) Provisional application No. 63/403,048, filed on Sep. 1, 2022.

(51) Int. Cl. F15B 1/04; B65G 5/00

(52) U.S. Cl. CPC F15B 1/04; B65G 5/00

(57) ABSTRACT

Methods for developing geomechanical pumped energy storage systems whereby energy is stored as mechanical energy by injecting a working fluid into a formation and producing the working fluid from the formation while generating power or performing work. The method is particularly adapted to storage of large amounts of energy such as in grid-scale electric energy systems. The formation may exhibit overpressure conditions, may comprise isolated stratigraphic or structural traps of reasonable size, or may comprise depleted oil and gas assets repurposed for storing energy.

### CROSS-REFERENCE TO RELATED APPLICATIONS

This application claims priority to U.S. Provisional Application No. 63/403,048, filed Sep. 1, 2022, the disclosures of which are herein incorporated by reference in their entirety.

### STATEMENT REGARDING FEDERALLY SPONSORED RESEARCH OR DEVELOPMENT

Not applicable.

### BACKGROUND OF THE INVENTION

### Field of the Invention

The present invention relates to energy storage. More particularly, a working fluid is pumped into a formation under pressure through a well to store energy and later produced from the formation under pressure to generate power or perform work.

### Background of the Invention

As the world's energy supply chain continues to experience a fundamental transformation toward more fully embracing renewable technologies, demand for reliable and cost-effective methods of balancing grid fluctuations and storing excess generation are expected to increase. Pumped hydro storage systems have a long history of meeting these balance and storage needs, however traditional pumped hydro implementations are typically limited in their ability to expand beyond the geographies offering elevated terrains on which they depend.

Recently, novel forms of pumped hydro storage which incorporate geomechanical pumped storage systems have been pioneered, and such systems have demonstrated an ability to meet balance and storage objectives at very favorable cost profiles. For example, U.S. Pat. No. 8,763,387 titled “Hydraulic Geofracture Energy Storage System,” incorporated herein in its entirety by reference thereto, discloses systems and methods through which grid-scale electric energy may be stored for short or long durations by injecting a working fluid into a hydraulic fracture in a formation and subsequently producing the fluid from the fracture to generate power. This form of storage technology has been found to be extendable to provide ancillary benefits, for example desalination of a working fluid containing salt as disclosed in U.S. patent application Ser. No. 17/481,108 titled “Hydraulic Geofracture Energy Storage System with Desalination,” which is incorporated in its entirety herein by reference thereto. These systems, however, have been primarily directed to exploiting geologies wherein hydrostatic pressure gradients govern overall system design.

Overpressure environments, where fluid pressures exceed hydrostatic equilibrium, may be found in geologies where fluid conductivity may be inhibited or in formations associated with large forcing mechanisms. A thorough understanding of overpressure systems can be gained from the publication “Offshore Sediment Overpressures of Passive Margins: Mechanisms, Measurement, and Models” by B. Dougan and T. C. Sheahan, published in Reviews of Geophysics by the American Geophysics Union (2012), the entire contents of which is incorporated herein by reference thereto. Development of overpressure systems can introduce additional complexities over traditional systems which may need to be accounted for, examples of which may include higher mechanical instability of the formation and a need to effectively manage higher pressure variations throughout the working cycle. As demand for systems capable of balancing grid fluctuations and storing excess generation increases, it is anticipated there will be increased interest in expanding the footprint of locations suitable for hosting geomechanical pumped storage to include sites featuring overpressure conditions. Consequently, there is a need in the art for methods of developing geomechanical pumped storage systems in environments where overpressure conditions may prevail.

Various processes and systems may have been proposed and utilized for employing a working fluid pumped into a formation under pressure through a well to store energy and later produced from the formation under pressure to generate power or perform work, including some of the processes and systems disclosed in the references appearing on the face of this patent. However, those processes and systems lack all the steps or features of the processes and systems covered by any patent claims below. As will be apparent to a person of ordinary skill in the art, any processes and systems covered by claims of the issued patent solve many of the problems that prior art processes and systems have failed to solve. Also, the processes and systems covered by at least some of the claims of this patent have benefits that could be surprising and unexpected to a person of ordinary skill in the art based on the prior art existing at the time of invention.

### BRIEF SUMMARY OF SOME OF THE PREFERRED EMBODIMENTS

These and other needs in the art are addressed in one embodiment by a method for storing and producing energy, comprising injecting an incompressible working fluid into a subsurface formation under a pressure; storing the working fluid within the formation under the pressure for a period of time; reducing the pressure so as to produce a portion of the fluid up the well and using the produced fluid to generate power or perform work. In embodiments, the subsurface formation may comprise overpressure conditions, one or more isolated stratigraphic or structural traps, or a depleted oil and gas field or reservoir, or may be accessed by an existing wellbore characterized as a “dry hole”.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### DETAILED DESCRIPTION OF THE PREFERRED EMBODIMENTS

A detailed description will now be provided. The purpose of this detailed description, which may include drawings, is to satisfy the statutory requirements of 35 U.S.C. § 112. For example, the detailed description includes a description of the inventions defined by the claims and sufficient information that would enable a person having ordinary skill in the art to make and use the inventions. In the figures, if any, like elements are generally indicated by like reference numerals regardless of the view or figure in which the elements may appear. The figures, if any, are intended to assist the description and to provide a visual representation of certain aspects of the subject matter described herein. The figures, if any, are not all necessarily drawn to scale, nor do they show all the structural details of the systems, nor do they limit the scope of the claims.

Each of the appended claims defines a separate invention which, for infringement purposes, is recognized as including equivalents of the various elements or limitations specified in the claims. Depending on the context, all references below to the “invention” may in some cases refer to certain specific embodiments only. In other cases, it will be recognized that references to the “invention” will refer to the subject matter recited in one or more, but not necessarily all, of the claims. Each of the inventions will now be described in greater detail below, including specific embodiments, versions, and examples, but the inventions are not limited to these specific embodiments, versions, or examples, which are included to enable a person having ordinary skill in the art to make and use the inventions when the information in this patent is combined with available information and technology. Various terms as used herein are defined below, and the definitions should be adopted when construing the claims that include those terms, except to the extent a different meaning is given within the specification or in express representations to the Patent and Trademark Office (PTO). To the extent a term used in a claim is not defined below or in representations to the PTO, it should be given the broadest definition persons having skill in the art have given that term as reflected in any printed publication, dictionary, or issued patent.

Emerging geomechanical pumped storage systems employ an incompressible working fluid, for example water, which can be injected into a subsurface formation under pressure, stored for a period of time within the formation under pressure, and subsequently produced from the formation in order to generate power. During injection, pressure may be applied to the working fluid sufficient to drive the working fluid into and elastically flex the formation. The working fluid may then be held under pressure within the formation, thereby storing energy as a function of the flexure of the rock. When desired, the working fluid may later be produced back to the surface by relaxing the pressure acting to contain the working fluid in the formation, which in turn allows the formation to return toward a relaxed state and drive the working fluid out of the formation. Upon being produced from the formation in this manner, the produced working fluid may then be exploited to produce power or perform other forms of work.

For purposes of evaluating the suitability of a formation for use in geomechanical pumped storage systems, the formation may broadly be characterized as comprising a contained volume or an infinite volume. Contained volumes may be large in size, but bounded, with negligible or zero loss, such that hydrostatic pressure within the formation may be exceeded given enough working pressure acting against the hydrostatic. In contrast, formations comprising infinite volumes may exhibit some form of fluid conductance away from the volume naturally, or provide channels for pressure loss as a working pressure is applied against the hydrostatic pressure. Contained volumes are therefore naturally preferable over infinite volumes for storing energy, since infinite volumes may necessitate that working pressures be continually adjusted to account for any conductance away from the volume. Understandably, systems exhibiting little fluid loss, ideally zero, are desirable, and the most suitable rock strata may be those which are completely impermeable, however pumped energy storage may also be implemented through systems including highly permeable rock which may be sealed structurally, stratigraphically, or against an infinite volume which may be sealed, for example by an impermeable cap rock.

The geomechanical pumped storage systems disclosed in the art have placed focus on contained volumes comprising low permeability geologies along with a fracture at a stratum of interest to increase the effective productive surface area of the system. Under certain conditions, the fracture may be treated in order to reduce the permeability of rock, which may serve to increase the efficiency of the system. However, such geomechanical storage systems may be extended to include isolated subsurface reservoirs not employing fractures. Further, contained volumes naturally exhibiting overpressure characteristics, wherein fluid pressure within the structure exceeds hydrostatic equilibrium, may also be suitable for implementing geomechanical pumped storage systems.

In embodiments, geologies comprising isolated stratigraphic traps of reasonable size may offer attractive characteristics where appropriate amounts of fluid injection may charge the system above hydrostatic pressure. For example, candidate formations may include silurian reefs such as those found across the US states of Michigan, Ohio, and Illinois; turbidites such as the Cretaceous Interior Seaway, the Devonian in the Appalachian Basin, the Pennsylvanian in the Arkoma and Fort Worth Basins, and the Mio-Pliocene in the US state of California; and fluvio-deltaic formations such as point bars, crevasse splays, or the mouth bars of the Gulf Coast and Mid Continent. Similarly, in embodiments, geologies comprising isolated structural traps of reasonable size may be attractive where appropriate amounts of fluid injection may charge the system above hydrostatic pressure. For example, such formations may include the salt diapir traps of the Gulf Coast, anticline traps such as those found in the US state of California or across the US Rockies, or the Jurassic carbonate buildups of the East Texas Basin. Formations exhibiting such stratigraphic or structural traps may not always present overpressure conditions, although many will.

Depleted oil and gas fields, as well as dry holes, may also be suitable for conversion and redevelopment as geomechanical pumped storage systems. In embodiments, depleted fields may need to be sized such that the volume of fluid necessary to be pumped into the depleted field above the hydrostatic gradient (i.e., in order to produce back from the depleted field a suitable volume of fluid capable of generating energy or performing work which may be commercially viable) can be reasonably contained in a surface impoundment or water body unless an adjacent shallower field or reservoir may be available. Repurposing depleted fields in this manner may offer sizable storage capacities capable of serving a broad spectrum of international energy markets.

In embodiments, dry holes may require well-bore specific considerations to be evaluated to determine suitability for conversion to energy storage. For example, initial production tests based on water cut or flow rate cut-off may indicate suitability, and databases including wellbore details may assist in identifying a population of candidate dry holes suitable for conversion. In embodiments, any dry hole showing significant water flow rates may be repurposed for energy storage, assuming its associated reservoir size may be suitable to be refilled above the hydrostatic gradient.

Other embodiments of suitable formations may comprise limited bodies of porous media, such as sand stringers in overpressure regions where pore pressure may be comparable to lithostatic gradient, for example the Texas gulf coast in the Frio or Wilcox formations.

Across this spectrum of geologic focus, a variety of methods may be employed in order to prepare the desired formation for use in pumped energy storage applications. For example, in depleted conventional reservoirs comprising stratigraphic or structural traps, overpressure may be re-introduced into the depleted reservoir. In embodiments, such reservoirs may be bound by a caprock, and working pressures of the system may need to be maintained below any fracturing pressure of the caprock. Where caprock structures may not be present, a depleted reservoir may still be found to be suitable for pumped energy storage in formations presenting unbounded aquifer drives, although in operation such systems may exhibit lower working efficiencies.

Whether a formation comprising a porous media may be bounded or not, entry friction from a wellbore into the formation may be substantial, thus requiring additional work, consuming more energy, and leading to a less efficient pumped energy storage system. In an embodiment of particular interest, where friction from flow into or out of a wellbore may be only moderately greater than desired, for example a factor of 2 to 5 times a desired rate of friction, friction may be reduced by increasing the surface area of the system by expanding the open-hole contact region at a desired location with a reamer.

In alternate embodiments, propped fractures may be used to increase the working surface area in systems where a much larger reduction in entry or exit friction may be desired. Where the media may be porous, the net pressure may equilibriate with pore pressure rapidly, and proppant may be employed in order to maintain a flow path for the working fluid. In such embodiments, the proppant employed may comprise very large particles, for example gravel-size proppants or larger.

In embodiments where a fracture may be desired in a conventional reservoir, the fracturing pressure of the surrounding formation may be artificially lowered by notching a desired strata as described in U.S. Patent Application No. 63/331,002, the entire content of which is incorporated herein by reference thereto. In such applications, remaining storage capacities may be directed to the conventional reservoir, however the near-wellbore flow may be directed through water-propped or physically-propped portions of the reservoir in order to provide improved efficiencies.

Although the present invention and its advantages have been described in detail, it should be understood that various changes, substitutions and alterations may be made herein without departing from the spirit and scope of the invention as defined by the appended claims.

What is claimed is:

1. A method for storing and producing energy, comprising:
evaluating the suitability of a subsurface formation;
injecting an incompressible working fluid into the subsurface formation under a pressure, wherein the pressure applied to the working fluid is sufficient to drive the working fluid into and elastically flex the subsurface formation;
storing the working fluid within the subsurface formation under the pressure for a period of time, wherein energy is stored as a function of the flexure of the subsurface formation;
reducing the pressure so as to produce a portion of the working fluid, wherein the subsurface formation returns to a relaxed state; and
employing the produced working fluid to generate power or perform work.

2. The method of claim 1, wherein the subsurface formation comprises overpressure conditions at one or more depths.

3. The method of claim 1, wherein the subsurface formation comprises one or more isolated stratigraphic traps.

4. The method of claim 1, wherein the subsurface formation comprises one or more isolated structural traps.

5. The method of claim 1, wherein the subsurface formation comprises a depleted oil and gas field or reservoir.

6. The method of claim 5, wherein the depleted oil and gas field or reservoir is sized, wherein the volume of working fluid necessary to be pumped into the depleted field above the hydrostatic gradient is reasonably contained in a surface impoundment.

7. The method of claim 1, wherein the subsurface formation comprises a drilled well, wherein the drilled well is a dry hole.

8. The method of claim 7, wherein the method further comprises conducting an initial production test based on water cut or flow rate cut-off to evaluate suitability of the dry hole.
